(19) United States
(12) Patent Application Publication
(10) Pub. No.: US 2024/0019707 A1
(43) Pub. Date: Jan. 18, 2024

(54) OPTICAL SYSTEM AND LASER DEVICE INCLUDING THE SAME

(71) Applicant: Samsung Display Co., LTD., Yongin-si (KR)

(72) Inventors: JONGOH SEO, Yongin-si (KR); JI-HWAN KIM, Hwaseong-si (KR); JONGHOON CHOI, Hwaseong-si (KR)

(21) Appl. No.: 18/347,447

(22) Filed: Jul. 5, 2023

(30) Foreign Application Priority Data
Jul. 13, 2022 (KR) 10-2022-0086476

(51) Int. Cl. G02B 27/09

(52) U.S. Cl. CPC G02B 27/0916; G02B 27/0977; G02B 27/0955

(57) ABSTRACT

An optical system includes: a splitter reflecting a portion of a laser beam to form a reflected laser beam, and transmitting a portion of the laser beam to form a transmitted laser beam; a reflection module reflecting the laser beam from the splitter; an inversion module including a first lens having a first focal length and a first incident surface and a first exit surface opposite to the first incident surface, and a second lens having a second focal length and including a second incident surface and a second exit surface opposite to the second incident surface, in which the laser beam sequentially passes through the first lens and the second lens so that the transmitted laser beam is converted into an inverted laser beam; and a combiner reflecting the laser beam reflected from the reflection module and transmitting the inverted laser beam emitted from the inversion module.

### CROSS-REFERENCE TO RELATED APPLICATION

The present application claims priority to and the benefit of Korean Patent Application No. 10-2022-0086476 filed on Jul. 13, 2022 in the Korean Intellectual Property Office (KIPO), the entire disclosure of which is incorporated herein by reference.

### BACKGROUND

### 1. Field

Aspects of some embodiments of the present disclosure relate to an optical system and a laser device including the same.

### 2. Description of the Related Art

In general, as a method for crystallizing an amorphous silicon layer into a polycrystalline silicon layer, solid phase crystallization (SPC), metal induced crystallization (MIC), metal induced lateral crystallization (MILC), and excimer laser annealing (ELA) are used. For example, the excimer laser annealing for crystallizing amorphous silicon into polycrystalline silicon using a laser beam is mainly used in a manufacturing process of an organic light emitting display device or a liquid crystal display device.

A laser device used in the excimer laser annealing (ELA) includes a laser generator that generates a source laser beam. The source laser beam is an initial laser beam that is not processed and has a rectangular cross section having a major axis and a minor axis. The source laser beam has energy distribution of a Gaussian distribution in both the major axis direction and the minor axis direction. The Gaussian distribution refers to a normal distribution that is laterally symmetrical about the mean.

However, when shaking occurs between a plurality of shots of the laser device, the energy distribution of the source laser beam may deviate from the normal distribution and may become laterally asymmetric. In this case, crystallization defects may occur in the polycrystalline silicon layer. For this reason, complex optical systems have been developed to remove the asymmetry of the source laser beam, but there may be problems in that light efficiency is lowered because a large number of optical lenses may be required, space may be limited, and beam alignment may be difficult.

The above information disclosed in this Background section is only for enhancement of understanding of the background and therefore the information discussed in this Background section does not necessarily constitute prior art.

### SUMMARY

Aspects of some embodiments of the present disclosure relate to an optical system and a laser device including the same, and for example, to an optical system used in excimer laser annealing (ELA) and a laser device including the same.

Some embodiments of the present disclosure include an optical system with relatively improved light efficiency.

According to some embodiments of the present disclosure, a laser device includes the optical system.

However, the characteristics of embodiments according to the present disclosure are not limited to the above-described characteristics, and may be variously expanded without departing from the spirit and scope of embodiments according to the present disclosure.

According to some embodiments of the present disclosure, an optical system includes: a splitter configured to reflect a portion of a laser beam to form a reflected laser beam, and transmit a portion of the laser beam to form a transmitted laser beam; a reflection module configured to reflect the reflected laser beam reflected from the splitter; an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and a combiner configured to reflect the reflected laser beam reflected from the reflection module and transmit the inverted laser beam emitted from the inversion module.

According to some embodiments, the reflection module may include 2n mirrors (wherein n is a natural number equal to or greater than 1).

According to some embodiments, the reflection module may include: a first mirror configured to reflect the reflected laser beam reflected from the splitter; and a second mirror configured to transmit the reflected laser beam to the combiner by reflecting the reflected laser beam reflected from the first mirror.

According to some embodiments, the first exit surface of the first lens and the second incident surface of the second lens may be opposite to each other.

According to some embodiments, the first exit surface of the first lens and the second incident surface of the second lens may be parallel to each other.

According to some embodiments, the first incident surface of the first lens may have a curved shape that is convex in a direction from the first exit surface of the first lens toward the first incident surface of the first lens, and the second exit surface of the second lens may have a curved shape that is convex in a direction from the second incident surface of the second lens toward the second exit surface of the second lens.

According to some embodiments, each of a focus of the first lens and a focus of the second lens may be a first focus, and the first focus may be located between the first exit surface of the first lens and the second incident surface of the second lens.

According to some embodiments, a spacing distance between the splitter and the first lens may be equal to the first focal length, and a spacing distance between the combiner and the second lens may be equal to the second focal length.

According to some embodiments, the second focal length may be greater than the first focal length.

According to some embodiments, the second focal length may be 1.2 times or more of the first focal length and 1.6 times or less of the first focal length.

According to some embodiments, an optical axis of the first lens may be the same as an optical axis of the second lens.

According to some embodiments, the reflected laser beam reflected from the combiner and the inverted laser beam passing through the combiner may be positioned on the same straight line.

According to some embodiments of the present disclosure, a laser device includes: a first homogenizer configured to convert a first laser beam into a first homogenizing laser beam, and including a first homogenizing optical system and a second homogenizing optical system; a second homogenizer configured to convert a second laser beam into a second homogenizing laser beam, and including a third homogenizing optical system and a fourth homogenizing optical system; and a third homogenizer configured to convert the first homogenizing laser beam and the second homogenizing laser beam into a third homogenizing laser beam, and each of the first homogenizing optical system, the second homogenizing optical system, the third homogenizing optical system and the fourth homogenizing optical system may include: a splitter configured to reflect a portion of a laser beam to form a reflected laser beam, and transmit a portion of the laser beam to form a transmitted laser beam; a reflection module configured to reflect the reflected laser beam reflected from the splitter; an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and a combiner configured to reflect the reflected laser beam reflected from the reflection module and transmit the inverted laser beam emitted from the inversion module.

According to some embodiments, the first homogenizer may further include a first transmission optical system configured to transmit the laser beam emitted from the first homogenizing optical system to the second homogenizing optical system, and the second homogenizer may further include a second transmission optical system configured to transmit the laser beam emitted from the third homogenizing optical system to the fourth homogenizing optical system.

According to some embodiments, the first transmission optical system may include a first reflection mirror configured to reflect the laser beam emitted from the combiner of the first homogenizing optical system, and a second reflection mirror configured to reflect the laser beam reflected from the first mirror to transmit the laser beam to the splitter of the second homogenizing optical system, and the second transmission optical system may include a third reflection mirror configured to reflect the laser beam emitted from the combiner of the third homogenizing optical system, and a fourth reflection mirror configured to reflect the laser beam reflected from the third mirror to transmit the laser beam to the splitter of the fourth homogenizing optical system.

According to some embodiments, the first homogenizer may further include a first lens array configured to convert the laser beam emitted from the second homogenizing optical system into the first homogenizing laser beam, and the second homogenizer may further include a second lens array configured to convert the laser beam emitted from the fourth homogenizing optical system into the second homogenizing laser beam.

According to some embodiments, each of the first lens array and the second lens array may include: a minor-axis homogenizing lens array including a first minor-axis homogenizing lens and a second minor-axis homogenizing lens; and a major-axis homogenizing lens array including a first major-axis homogenizing lens and a second major-axis homogenizing lens.

According to some embodiments, the major-axis homogenizing lens array may be located between the first minor-axis homogenizing lens and the second minor-axis homogenizing lens.

According to some embodiments, the first homogenizer may further include a third transmission optical system configured to transmit the laser beam emitted from the second homogenizing optical system to the first lens array, and the second homogenizer may further include a fourth transmission optical system configured to transmit the laser beam emitted from the fourth homogenizing optical system to the second lens array.

According to some embodiments, the third transmission optical system may include a first splitter configured to reflect a portion of the laser beam emitted from the second homogenizing optical system and transmit a portion of the laser beam, and a fifth reflection mirror configured to reflect the laser beam reflected from the first splitter to transmit the laser beam to the first lens array, and the fourth transmission optical system may include a second splitter configured to reflect a portion of the laser beam emitted from the fourth homogenizing optical system and transmit a portion of the laser beam, and a sixth reflection mirror configured to reflect the laser beam reflected from the second splitter to transmit the laser beam to the second lens array.

According to some embodiments, the first homogenizer may further include a first inspection device configured to inspect a dispersion characteristic of the laser beam that has passed through the first splitter, and the second homogenizer may further include a second inspection device configured to inspect a dispersion characteristic of the laser beam that has passed through the second splitter.

According to some embodiments, the third homogenizer may include: a fifth transmission optical system configured to reflect the first homogenizing laser beam; a sixth transmission optical system configured to reflect the second homogenizing laser beam; a third splitter configured to reflect a portion of each of the first homogenizing laser beam reflected from the fifth transmission optical system and the second homogenizing laser beam reflected from the sixth transmission optical system, and transmit a portion of each of the first homogenizing laser beam reflected from the fifth transmission optical system and the second homogenizing laser beam reflected from the sixth transmission optical system; and a fourth splitter configured to reflect a portion of each of the first homogenizing laser beam reflected from the third splitter and the second homogenizing laser beam transmitted through the third splitter, and transmit a portion of each of the first homogenizing laser beam reflected from the third splitter and the second homogenizing laser beam transmitted through the third splitter.

According to some embodiments, the fifth transmission optical system may include a seventh reflection mirror configured to reflect the first homogenizing laser beam and an eighth reflection mirror configured to reflect the first homogenizing laser beam reflected from the seventh reflection mirror to transmit the first homogenizing laser beam to the third splitter, and the sixth transmission optical system may include a ninth reflection mirror configured to reflect the second homogenizing laser beam to transmit the second homogenizing laser beam to the third splitter.

According to some embodiments, the first homogenizing laser beam reflected from the eighth reflection mirror may be incident onto a first surface of the third splitter, and the second homogenizing laser beam reflected from the ninth reflection mirror may be incident onto a second surface opposite to the first surface of the third splitter.

According to some embodiments, the third homogenizer may further include a third inspection device configured to inspect waveform characteristics of the laser beam that has passed through the fourth splitter.

According to some embodiments, the third homogenizer may further include a homogenizer configured to convert the first homogenizing laser beam transmitted through the third splitter and the second homogenizing laser beam reflected from the third splitter into a third homogenizing laser beam.

According to some embodiments, the homogenizer may be configured to further convert the laser beam reflected from the fourth splitter into the third homogenizing laser beam.

An optical system according to some embodiments of the present disclosure may include: a splitter configured to reflect a portion of a laser beam to form a reflected laser beam, and transmit a portion of the laser beam to form a transmitted laser beam; a reflection module configured to reflect the reflected laser beam reflected from the splitter; an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and a combiner configured to reflect the reflected laser beam reflected from the reflection module and transmit the inverted laser beam emitted from the inversion module.

According to some embodiments, the inverted laser beam may have a symmetrical phase distribution with respect to a phase distribution of the first laser beam incident into the splitter about the origin, and the reflected laser beam reflected from the splitter may have a phase distribution substantially the same as that of the first laser beam incident into the splitter. In this case, the second laser beam emitted from the combiner may be a laser beam obtained by mixing the inverted laser beam and the reflected laser beam reflected from the splitter, and the laser beam may have a phase distribution that is more homogenized compared to the first laser beam.

According to some embodiments, a laser device may include: a first homogenizer configured to convert a first laser beam into a first homogenizing laser beam, and including a first homogenizing optical system and a second homogenizing optical system; a second homogenizer configured to convert a second laser beam into a second homogenizing laser beam, and including a third homogenizing optical system and a fourth homogenizing optical system; and a third homogenizer configured to convert the first homogenizing laser beam and the second homogenizing laser beam into a third homogenizing laser beam, and each of the first homogenizing optical system, the second homogenizing optical system, the third homogenizing optical system and the fourth homogenizing optical system may include: a splitter configured to reflect a portion of a laser beam to form a reflected laser beam, and transmit a portion of the laser beam to form a transmitted laser beam; a reflection module configured to reflect the reflected laser beam reflected from the splitter; an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and a combiner configured to reflect the reflected laser beam reflected from the reflection module and transmit the inverted laser beam emitted from the inversion module.

Accordingly, the phase distribution of the laser beam emitted from each of the first to fourth homogenizing optical systems may be more homogenized compared to the phase distribution of the laser beam incident into each of the first to fourth homogenizing optical systems, and the laser beam emitted from the laser device may have a more homogenized phase distribution.

However, the characteristics of embodiments according to the present disclosure are not limited to the above-described effect, and may be variously expanded without departing from the spirit and scope of embodiments according to the present disclosure.

### BRIEF DESCRIPTION OF THE DRAWINGS

FIG. 1 is a view for explaining an optical system according to some embodiments of the present disclosure.

FIGS. 2 and 3 are views for explaining an inversion module included in the optical system of FIG. 1.

FIG. 4 is a view for explaining an optical system according to some embodiments of the present disclosure.

FIG. 5 is a block diagram showing a laser device according to some embodiments of the present disclosure.

FIG. 6 is a view for explaining a first homogenizer included in the laser device of FIG. 5 according to some embodiments of the present disclosure.

FIG. 7 is a view for explaining a third homogenizer included in the laser device of FIG. 5 according to some embodiments of the present disclosure.

### DETAILED DESCRIPTION

Hereinafter, aspects of some embodiments of the present disclosure will be described in more detail with reference to the accompanying drawings. The same or similar reference numerals will be used for the same components in the accompanying drawings.

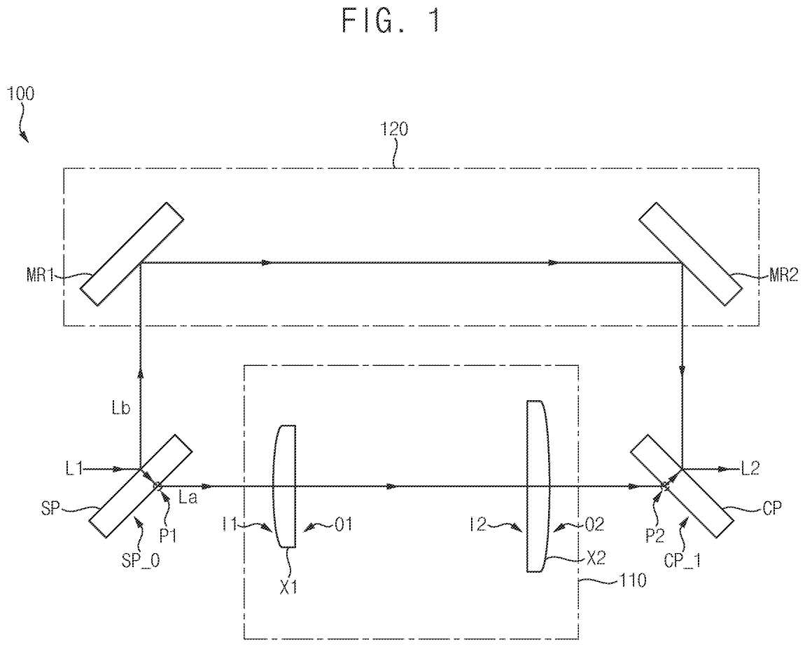

FIG. 1 is a view for explaining an optical system according to some embodiments of the present disclosure.

Referring to FIG. 1, an optical system 100 according to some embodiments of the present disclosure may convert a laser beam L1 into a homogenizing laser beam L2. To this end, the optical system 100 may include a splitter SP, a reflection module 120, an inversion module 110, and a combiner CP.

The splitter SP may split the laser beam L1. For example, the splitter SP may form a transmitted laser beam La (e.g., a first transmitted laser beam La) by transmitting a portion of the laser beam L1, and may form a reflected laser beam Lb (e.g., a second transmitted laser beam Lb) by reflecting a portion of the laser beam 1.

The reflection module 120 may reflect the reflected laser beam Lb to transmit the reflected laser beam Lb to the combiner CP. To this end, the reflection module 120 may include an even number of mirrors that reflect the reflected laser beam Lb. For example, the reflection module 120 may include 2n mirrors (n is a natural number greater than or equal to 1).

As the reflection module 120 includes the even number of mirrors, the phase of the laser beam Lb reflected by the even number of mirrors may not substantially change. For example, when the laser beam Lb is reflected by one mirror, the phase of the laser beam Lb may be inversed in the vertical or horizontal direction. In this case, if the laser beam Lb having the phase inverted in the vertical or horizontal direction is reflected again by another mirror, the phase of the laser beam Lb may be substantially the same as the phase of the laser beam Lb before being reflected by the one mirror. That is, when the laser beam Lb is reflected an even number of times by the even number of mirrors, the phase of the laser beam Lb may not change substantially.

According to some embodiments, the reflection module 120 may include two mirrors. More specifically, as shown in FIG. 1, the reflection module 120 may include a first mirror MR1 that reflects the reflected laser beam Lb reflected from the splitter SP, and a second mirror MR2 that reflects the reflected laser beam Lb reflected from the first mirror MR1 to transmit the reflected laser beam Lb to the combiner CP. Accordingly, the phase of the laser beam Lb reflected by the reflection module 120 may not change substantially, and the space efficiency of the optical system 100 may be improved because the number of mirrors included in the reflection module 120 can be relatively reduced.

The inversion module 110 may convert the transmitted laser beam La into the inverted laser beam by inverting the phase of the transmitted laser beam La about the origin. To this end, the inversion module 110 may include a first lens X1 and a second lens X2.

The first lens X1 may include a first incident surface I1 onto which the transmitted laser beam La passing through the splitter SP is incident, and a first exit surface O1 through which the transmitted laser beam La incident into the first lens X1 is emitted. The second lens X2 may include a second incident surface I2 onto which the laser beam emitted from the first exit surface O1 of the first lens X1 is incident, and a second exit surface O2 through which the laser beam incident into the second lens X2 is emitted. The laser beam emitted from the second exit surface O2 of the second lens X2 may be referred to as the inverted laser beam. In other words, the inverted laser beam may be a converted laser beam which is obtained as the transmitted laser beam La sequentially passes through the first lens X1 and the second lens X2.

The first exit surface O1 of the first lens X1 and the second incident surface 12 of the second lens X2 may face each other. In this case, each of the first exit surface O1 of the first lens X1 and the second incident surface I2 of the second lens X2 may have a substantially flat surface, and the first exit surface O1 of the first lens X1 may be parallel to the second incident surface I2 of the second lens X2.

The first incident surface I1 of the first lens X1 may have a curved surface that is convex in the direction from the first exit surface O1 of the first lens X1 toward the first incident surface I1 of the first lens X1. In addition, the second exit surface O2 of the second lens X2 may have a curved surface that is convex in the direction from the second incident surface I2 of the second lens X2 toward the second exit surface O2 of the second lens X2.

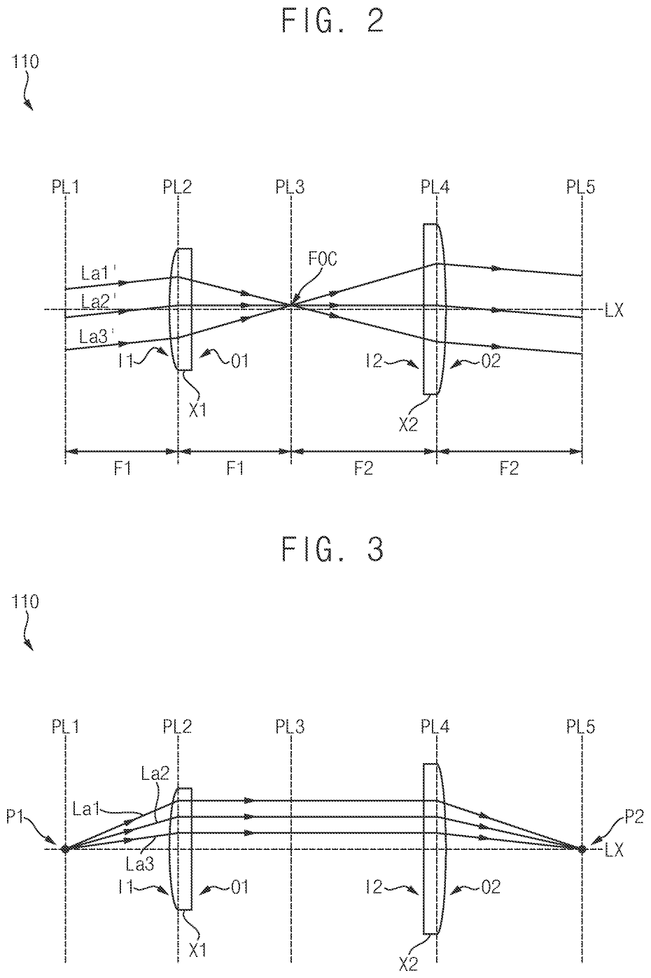

Because the first incident surface I1 and the first exit surface O1 of the first lens X1 and the second incident surface I2 and the second exit surface O2 of the second lens X2 have the above-described structure, the inversion module 110 may invert the phase of the transmitted laser beam La about the origin. This will be described in more detail later with reference to FIGS. 2 to 4.

The combiner CP may reflect the reflected laser beam Lb reflected from the reflection module 120 and transmit the inverted laser beam emitted from the inversion module 110. In this case, the reflected laser beam Lb reflected by the reflection module 120 and the inverted laser beam emitted from the inversion module 110 may be mixed with each other to form a homogenizing laser beam L2. In this case, the reflected laser beam Lb reflected from the combiner CP and the inverted laser beam passing through the combiner CP may be located substantially on the same straight line, and accordingly, the laser beam processed and emitted through the optical system 100 may be easily aligned.

FIGS. 2 and 3 are views for explaining the inversion module included in the optical system of FIG. 1.

Hereinafter, first to fifth planes PL1, PL2, PL3, PL4, PL5, the first focus FOC, the first focal length F1, and the second focal length F2, which are defined by optical characteristics of the first lens X1 and the second lens X2, will be described with reference to FIG. In FIG. 2, for the purpose of convenience of explanation, it is assumed that first to third beams La1′, La2′, and La3′ substantially parallel to each other are incident onto the first lens X1.

Referring to FIG. 2, an optical axis LX may be defined. The optical axis LX may be an optical axis of each of the first lens X1 and the second lens X2. That is, the first lens X1 and the second lens X2 may have the same optical axis.

The first to third beams La1′, La2′, and La3′ incident from the first plane PL1 onto the first lens X1 pass through the first lens X1 and then meet each other at the focus of the first lens X1. As shown in FIG. 2, the focus of the first lens X1 may be a first focus FOC located between the first exit surface O1 of the first lens X1 and the second incident surface I2 of the second lens X2, and the laser beams emitted from the first lens X1 may meet each other at the first focus FOC.

Based on the optical axis LX, the distance from the first lens X1 to the first focus FOC that is the focus of the first lens X1 may be defined as the focal length of the first lens X1. The focal length of the first lens X1 may be the focal length F1 that is a distance between a third plane PL3, which includes the first focus FOC and is defined as a plane parallel to the first plane PL1, and the first lens X1. In other words, the first focal length F1 may be defined as a spacing distance between the second plane PL2, which passes through at least a portion of the first lens X1 and is parallel to each of the first and third planes PL1 and PL3, and the third plane PL3.

The spacing distance between the first plane PL1 and the second plane PL2 may be the first focal length F1. That is, the spacing distance between the first plane PL1 and the second plane PL2 may be the same as the spacing distance between the second plane PL2 and the third plane PL3.

The laser beams passing through the focus of the first lens X1 may pass through the second lens X2. In this case, the focus of the second lens X2 may be substantially the same as the focus of the first lens X1. That is, the focus of the second lens X2 may be the first focus FOC. Accordingly, as shown in FIG. 2, the laser beams passing through the second lens X2 may be substantially parallel to each other.

Based on the optical axis LX, the distance from the second lens X2 to the first focus FOC that is the focus of the second lens X2 may be defined as the focal length of the second lens X2. The focal length of the second lens X2 may be the second focal length F2 that is a distance between the third plane PL3 including the first focus FOC and the second lens X2. In other words, the second focal length F2 may be defined as a spacing distance between the fourth plane PL4, which passes through at least a portion of the second lens X2 and is parallel to each of the first to third planes PL1, PL2, and PL3, and the third plane PL3.

The fifth plane PL5 may be a plane parallel to each of the first to fourth planes PL1, PL2, PL3, and PL4. The fifth plane PL5 may be a plane positioned on a traveling path of the laser beams passing through the second lens X2, and the spacing distance between the fifth plane PL5 and the fourth plane PL4 may be the second focus F2.

According to some embodiments, the second focal length F2 may be greater than the first focal length F1. For example, the second focal length F2 may be about 1.2 times or more of the first focal length F1 and about 1.6 times or less of the first focal length F1.

Hereinafter, the inversion module 110 including the first lens X1 and the second lens X2 will be described in more detail with reference to FIG. 3. Description of contents substantially the same as or similar to the contents described with reference to FIG. 2 may be omitted.

Referring to FIGS. 1 and 3, the transmitted laser beam La may be a linear laser beam. The transmitted laser beam La may be a beam emitted from a first point P1 of an exit surface SP_O of the splitter SP. The first point P1 may be a point where the first plane PL1 and the optical axis LX meet each other.

In this case, the transmitted laser beam La may travel in a direction crossing (or parallel to) the optical axis LX from the first point P1, and sequentially pass through the first lens X1 and the second lens X2. For example, the transmitted laser beam La may be any one of a first transmitted laser beam La1, a second transmitted laser beam La2, and a third transmitted laser beam La3.

Travel paths of each of the first to third transmitted laser beams La1, La2, and La3 may be different from each other. However, the first to third transmitted laser beams La1, La2, and La3 passing through the first lens X1 and the second lens X2 may meet the optical axis LX at the second point P2. The second point P2 may be a point where the optical axis LX meets the fifth plane PL5, or may be any one point on an incident surface CP_I of the combiner CP.

As described above, the first point P1 on the exit surface SP_O of the splitter SP and the second point P2 on the incident surface CP_I of the combiner CP may be located on the optical axis LX of the first lens X1 and the second lens X2. In addition, the spacing distance between the splitter SP and the first lens X1 (for example, the spacing distance between the first point P1 and the second plane PL2) may be the first focal length F1, and the spacing distance between the combiner CP and the second lens X2 (for example, the spacing distance between the second point P2 and the fourth plane PL4) may be the second focal length F2. Accordingly, regardless of the tilting degree of the laser beam emitted from the first point P1 with respect to the optical axis LX, the laser beam emitted from the first point P1 may pass through the second point P2.

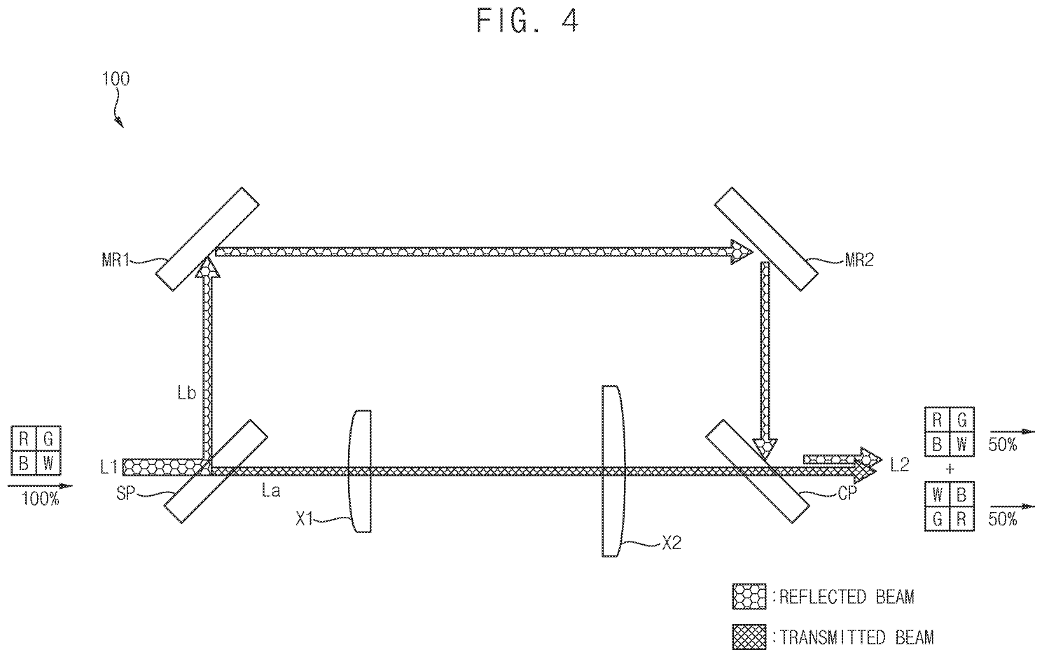

FIG. 4 is a view for explaining an optical system according to some embodiments of the present disclosure. FIG. 4 shows a case in which the transmitted laser beam La and the reflected laser beam Lb are divided by 50%:50%. The above ratio may be changed according to various embodiments.

Referring to FIGS. 1 and 4, for the purpose of convenience of explanation, it is assumed that the laser beam L1 before being incident onto the splitter SP has a phase distribution in which red (R) is arranged at the upper left, green (G) is arranged at the upper right, blue (B) is arranged at the lower left, and white (W) is arranged at the lower right.

A phase distribution of the reflected laser beam Lb reflected from the combiner CP may be the same as a phase distribution of the laser beam L1 before being incident onto the splitter SP. That is, the reflected laser beam Lb reflected from the combiner CP may have a phase distribution in which red (R) is arranged at the upper left, green (G) is arranged at the upper right, blue (B) is arranged at the lower left, and white (W) is arranged at the lower right.

Meanwhile, the inverted laser beam passing through the combiner CP may be inverted laterally and vertically (that is, the inversion about the origin). In other words, the transmitted laser beam La may be inverted laterally and vertically while passing through the first lens X1 and the second lens X2. That is, the inverted laser beam may have a phase distribution in which white (W) is arranged at the upper left, blue (B) is arranged at the upper right, green (G) is arranged at the lower left, and red (R) is arranged at the lower right.

Accordingly, the reflected laser beam Lb having the phase distribution the same as the phase distribution of the laser beam L1 may be mixed with the inverted laser beam having the phase distribution inverted symmetrically from the phase distribution of the laser beam L1 about the origin, so the energy distribution of the homogenizing laser beam L2 may be relatively more homogenized even when the energy distribution of the laser beam L1 is not homogenized. For example, when it is assumed that the laser beam L1 has a high energy density at the upper right, the reflected laser beam Lb has a high energy density at the upper right the same as the laser beam L1, and the inverted laser beam has a high energy density at the lower left. Accordingly, the energy distribution of the homogenizing laser beam L2, in which the reflected laser beam Lb and the inverted laser beam are mixed, may approach the normal energy distribution in which the energy distribution is symmetrical due to a high energy density at the central portion.

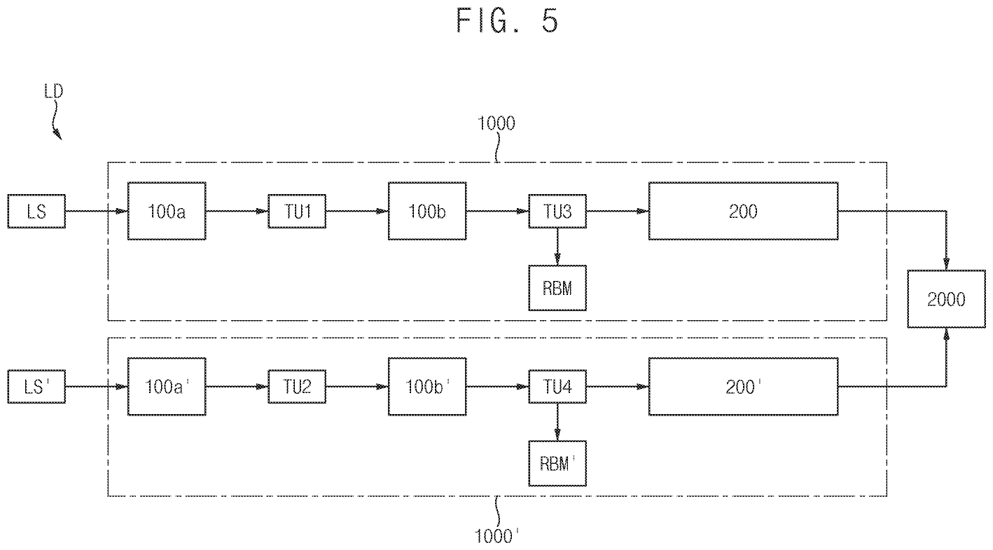

FIG. 5 is a block diagram showing a laser device according to some embodiments of the present disclosure.

Referring to FIG. 5, a laser device LD may include a first homogenizer 1000 configured to convert a first laser beam LS into a first homogenizing laser beam, a second homogenizer 1000′ configured to convert to a second laser beam LS′ into a second homogenizing laser beam, and a third homogenizer 2000 configured to convert the first homogenizing laser beam and the second homogenizing laser beam into a third homogenizing laser beam.

Each of the first laser beam LS and the second laser beam LS′ may be a linear laser beam. According to some embodiments, the first laser beam LS and the second laser beam LS′ may be substantially the same. However, embodiments according to the present disclosure are not limited thereto, and the first laser beam LS and the second laser beam LS′ may be different from each other in terms of optical characteristics such as phase and intensity.

The first homogenizer 1000 may include a first homogenizing optical system 100a, a second homogenizing optical system 100b, and a first lens array 200 in order to convert the first laser beam LS into the first homogenizing laser beam by homogenizing the first laser beam LS. In addition, the first homogenizer 1000 may include a first transmission optical system TU1 configured to transmit the laser beam emitted from the first homogenizing optical system 100a to the second homogenizing optical system 100b and a third transmission optical system TU3 configured to transmit the laser beam emitted from the second homogenizing optical system 100b to the first lens array 200′. Optionally, the first homogenizer 1000 may further include a first inspection device RBM that inspects a dispersion characteristic (for example, phase distribution) of a laser beam passing through the third transmission optical system TU3.

For example, the second homogenizer 1000′ may include a second homogenizing optical system 100a′, a fourth homogenizing optical system 100b′, and a second lens array 200′ in order to convert the second laser beam LS′ into the second homogenizing laser beam by converting the second laser beam LS′. In addition, the second homogenizer 1000′ may include a second transmission optical system TU2 configured to transmit the laser beam emitted from the second homogenizing optical system 100a′ to the fourth homogenizing optical system 100b′, and a fourth transmission optical system TU4 configured to transmit the laser beam emitted from the fourth homogenizing optical system 100b′ to the second lens array 200′. Optionally, the second homogenizer 1000′ may further include a second inspection device RBM′ for inspecting a dispersion characteristic of a laser beam passing through the fourth transmission optical system TU4.

The first homogenizer 1000 may be substantially the same as the second homogenizer 1000′. For example, the first transmission optical system TU1 may be substantially the same as the second transmission optical system TU2, the third transmission optical system TU3 may be substantially the same as the fourth transmission optical system TU4, and the first lens array 200 may be substantially the same as the second lens array 200′. In addition, each of the first to fourth homogenizing optical systems 100a, 100a′, 100b, and 100b′ may be substantially the same as the optical system 100 according to some embodiments of the present disclosure described with reference to FIGS. 1 to 4. Therefore, hereinafter, descriptions of the second homogenizer 1000′ and the first to fourth homogenizing optical systems 100a, 100a′, 100b and 100b′ will be omitted for the purpose of convenience of description.

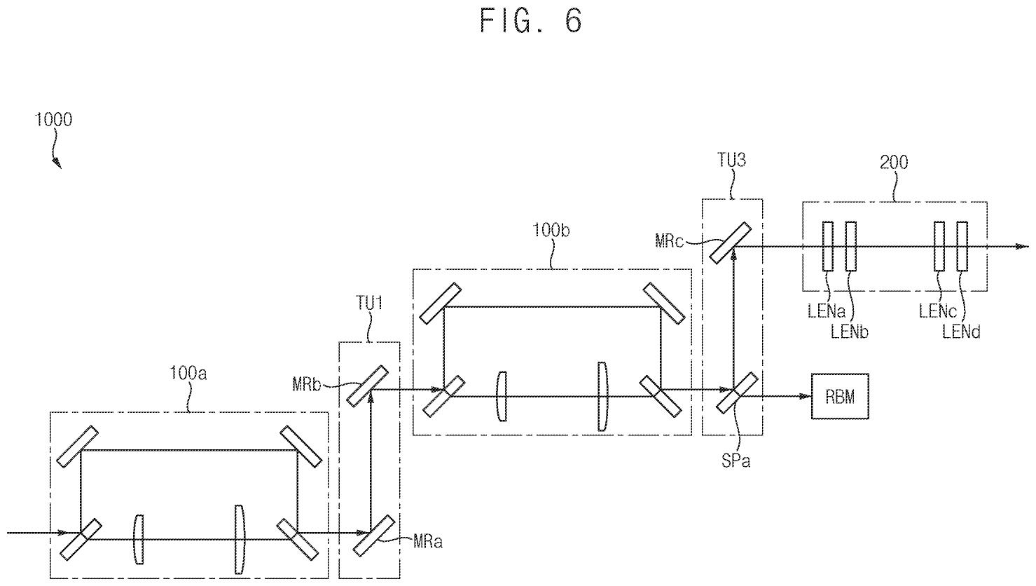

FIG. 6 is a view for explaining a first homogenizer included in the laser device of FIG. 5.

Referring to FIG. 6, the first homogenizer 1000 may include a first homogenizing optical system 100a, a first transmission optical system TU1, a second homogenizing optical system 100b, a third transmission optical system TU3, a first lens array 200, and a first inspection device RBM. The first laser beam LS incident onto the first homogenizer 1000 may be converted into the first homogenizing laser beam by sequentially passing through the first homogenizing optical system 100a, the first transmission optical system TU1, the second homogenizing optical system 100b, the third transmission optical system TU3, and the first lens array 200.

The laser beam emitted from the first homogenizing optical system 100a may be transmitted to the second homogenizing optical system 100b through the first transmission optical system TU1. To this end, the first homogenizing optical system 100a may include a first reflection mirror MRa and a second reflection mirror MRb.

The first reflection mirror MRa may reflect the laser beam emitted from the combiner of the first homogenizing optical system 100a to transmit the laser beam to the second reflection mirror MRb. The second reflection mirror MRb may reflect the laser beam reflected from the first reflection mirror MRa back to the splitter of the second homogenizing optical system 100b.

According to some embodiments, the second transmission optical system TU2 included in the second homogenizer 1000′ may include components substantially the same as the components of the first transmission optical system TU1. For example, the second transmission optical system TU2 may include a third reflection mirror that reflects the laser beam emitted from the combiner of the second homogenizing optical system 100a′ and a fourth reflection mirror that reflects the laser beam reflected from the third reflection mirror back to the splitter of the fourth homogenizing optical system 100b′.

The laser beam emitted from the second homogenizing optical system 100b may be transmitted to the first lens array 200 through the third transmission optical system TU3. To this end, the third transmission optical system TU3 may include a first splitter SPa that reflects a portion of the laser beam emitted from the second homogenizing optical system 100b and transmits a portion of the laser beam, and a fifth reflection mirror MRc that reflects the laser beam reflected from the first splitter SPa back to the first lens array 200.

In this case, the laser beam passing through the first splitter SPa may be transmitted to the first inspection apparatus RBM. Accordingly, the first inspection apparatus RMB may inspect a dispersion characteristic (for example, phase distribution) of the laser beam that has passed through the first splitter SPa.

According to some embodiments, the fourth transmission optical system TU4 included in the second homogenizer 1000′ may include components substantially the same as the components of the third transmission optical system TU3. For example, the fourth transmission optical system TU4 may include a second splitter that reflects a portion of the laser beam emitted from the fourth homogenizing optical system 100b′ and transmits a portion of the laser beam, and a sixth reflection mirror that reflects again the laser beam reflected from the second splitter to transmit the laser beam to the second lens array 200′. In this case, the laser beam passing through the second splitter may be transmitted to the second inspection device RBM′ that inspects a dispersion characteristics of the laser beam.

The first lens array 200 may include a plurality of lenses. According to some embodiments, the first lens array 200 may include a minor-axis homogenizing lens array for homogenizing the laser beam in one direction and a major-axis homogenizing lens array for homogenizing the laser beam in the other direction crossing the one direction. For example, the minor-axis homogenizing lens array may include a first minor-axis homogenizing lens LENa and a second minor-axis homogenizing lens LENd, and the major-axis homogenizing lens array may include a first major-axis homogenizing lens LENb and a second major-axis homogenizing lens LENc. Accordingly, the laser beam emitted from the third transmission optical system TU3 may pass through the first lens array 200 and may be homogenized in the one direction and the other direction.

According to some embodiments, the major-axis homogenizing lens array may be disposed between the first short-axis homogenizing lens LENa and the second short-axis homogenizing lens LENd. That is, the laser beam emitted from the third transmission optical system TU3 may sequentially pass through the first minor-axis homogenizing lens LENa, the first major-axis homogenizing lens LENb, the second major-axis homogenizing lens LENc, and the second minor-axis homogenizing lens LENd.

However, this is merely an example, and embodiments according to the present disclosure are not limited thereto. According to some embodiments, the minor-axis homogenizing lens array may be disposed between the first major-axis homogenizing lens LENb and the second major-axis homogenizing lens LENc. That is, the laser beam emitted from the third transmission optical system TU3 may sequentially pass through the first major-axis homogenizing lens LENb, the first minor-axis homogenizing lens LENa, the second minor-axis homogenizing lens LENd, and the second major-axis homogenizing lens LENc.

According to some embodiments, the second lens array 200′ included in the second homogenizer 1000′ may include components substantially the same as the components of the first lens array 200. For example, the second lens array 200′ may include a minor-axis homogenizing lens array for homogenizing the laser beam in the one direction and a major-axis homogenizing lens array for homogenizing the laser beam in the other direction.

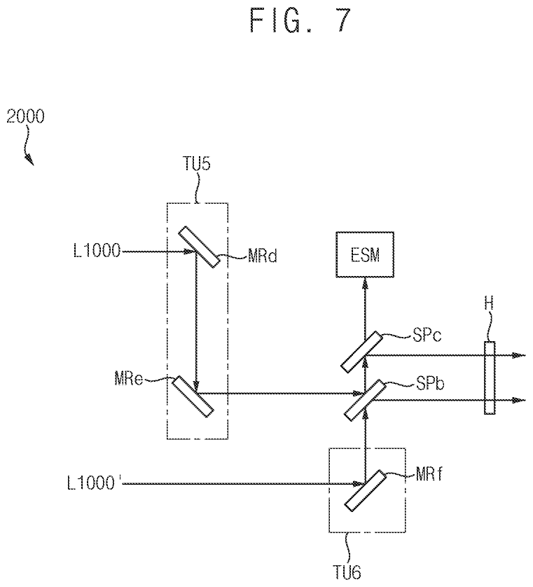

FIG. 7 is a view for explaining a third homogenizer included in the laser device of FIG. 5.

Referring to FIG. 7, the third homogenizer 2000 may include a fifth transmission optical system TU5, a sixth transmission optical system TU6, a third splitter SPb, a fourth splitter SPc, a homogenizer H, and a third inspection device ESM.

The fifth transmission optical system TU5 may reflect a first homogenizing laser beam L1000 emitted from the first homogenizer 1000 to transmit the first homogenizing laser beam L1000 to the third splitter SPb. To this end, the fifth transmission optical system TU5 may include a seventh reflection mirror MRd that reflects the first homogenizing laser beam L1000 and an eighth reflection mirror MRe that reflects the first homogenizing laser beam L1000 reflected from the seventh reflection mirror MRd to transmit the first homogenizing laser beam L1000 to the third splitter SPb. In this case, the first homogenizing laser beam L1000 may be incident onto a first surface of the third splitter SPb.

The sixth transmission optical system TU6 may reflect a second homogenizing laser beam L1000′ emitted from the second homogenizer 1000′ to transmit the second homogenizing laser beam L1000′ to the third splitter SPb. To this end, the sixth transmission optical system TU6 may include a ninth reflection mirror MRf that reflects the second homogenizing laser beam L1000′ to transmits the second homogenizing laser beam L1000′ to the third splitter SPb. In this case, the second homogenizing laser beam L1000′ may be incident onto a second surface of the third splitter SPb opposite to the first surface.

The third splitter SPb may reflect a portion of the first homogenizing laser beam L1000 reflected from the fifth transmission optical system TU5 and transmit a portion of the first homogenizing laser beam L1000. In addition, the third splitter SPb may reflect a portion of the second homogenizing laser beam L1000′ reflected from the sixth transmission optical system TU6 and transmit a portion of the second homogenizing laser beam L1000′.

In this case, the first homogenizing laser beam L1000 transmitted through the third splitter SPb and the second homogenizing laser beam L1000′ reflected from the third splitter SPb may be transmitted to the homogenizer H. In addition, the first homogenizing laser beam L1000 reflected from the third splitter SPb and the second homogenizing laser beam L1000′ transmitted through the third splitter SPb may be transmitted to the fourth splitter SPc.

The fourth splitter SPc may reflect a portion of the laser beam received from the third splitter SPb and transmit a portion of the laser beam. In this case, the laser beam reflected from the fourth splitter SPc may be transmitted to the homogenizer H, and the laser beam passing through the fourth splitter SPc may be transmitted to the third inspection device ESM that inspects the waveform characteristics of the laser beam. Accordingly, the waveform characteristics of the laser beam passing through the fourth splitter SPc may be inspected by the third inspection device ESM.

The homogenizer H may homogenize the laser beam received from the third splitter SPb and the laser beam received from the fourth splitter SPc to convert the laser beams into the third homogenizing laser beam.

As described above, the third homogenizer 2000 may form the third homogenizing laser beam by mixing and homogenizing the first homogenizing laser beam L1000 and the second homogenizing laser beam L1000′.

Referring again to FIGS. 5 to 7, the first laser beam LS may be converted into the first homogenizing laser beam L1000 while passing through the first homogenizer 1000, the second laser beam LS′ may be converted into the second homogenizing laser beam L1000′ while passing through the second homogenizer 1000′, and the first homogenizing laser beam L1000 and the second homogenizing laser beam L1000′ may be mixed into one laser beam while passing through the third homogenizer 2000 so that the third homogenizing laser beam may be formed.

Accordingly, even if each of the first laser beam LS and the second laser beam LS′ has a relatively low intensity (in this case, the first homogenizing laser beam L1000 and the second homogenizing laser beam L1000′ may also have a relatively low intensity), the third homogenizing laser beam, which is formed by mixing the first homogenizing laser beam L1000 and the second homogenizing laser beam L1000′, may have a relatively high intensity. In other words, the intensity of the third homogenizing laser beam may be substantially equal to (or similar to) the sum of the intensity of the first laser beam LS and the intensity of the second laser beam LS′, and thus, even if each of the first laser beam LS and the second laser beam LS′ has a relatively low intensity, the third homogenizing laser beam may have a relatively high intensity.

Meanwhile, if any one of the first homogenizer 1000 and the second homogenizer 1000′ is omitted, the intensity of the third homogenizing laser beam may not be sufficiently secured. For example, on the assumption that the second homogenizer 1000′ is omitted, the intensity of the third homogenizing laser beam may be substantially equal to (or similar to) the intensity of the first laser beam LS. In this case, the intensity of the first laser beam LS may be limited, so there is a problem that the maximum intensity of the first laser beam LS may be lower than the minimum intensity of the third homogenizing laser beam.

An organic light emitting display device and various electronic devices including the same can be manufactured by using the optical system and the laser device including the same of the present disclosure. For example, embodiments according to the present disclosure can be applied to manufacture a mobile phone, a smart phone, a video phone, a smart pad, a smart watch, a tablet PC, a vehicle navigation system, a television, a computer monitor, a notebook computer, a head mounted display, and the like.

Although it has been described with reference to some example embodiments of the present disclosure, it will be understood to those skilled in the art that various modifications and variations are possible without departing from the idea and scope of the present disclosure described in the claims and their equivalents.

What is claimed is:

1. An optical system comprising:
a splitter configured to reflect a portion of a laser beam to form a reflected laser beam, and to transmit a portion of the laser beam to form a transmitted laser beam;
a reflection module configured to reflect the reflected laser beam reflected from the splitter;
an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and
a combiner configured to reflect the reflected laser beam reflected from the reflection module and transmit the inverted laser beam emitted from the inversion module.

2. The optical system of claim 1, wherein the reflection module includes 2n mirrors (wherein n is a natural number equal to or greater than 1).

3. The optical system of claim 2, wherein the reflection module includes:
a first mirror configured to reflect the reflected laser beam reflected from the splitter; and
a second mirror configured to transmit the reflected laser beam to the combiner by reflecting the reflected laser beam reflected from the first mirror.

4. The optical system of claim 1, wherein the first exit surface of the first lens and the second incident surface of the second lens are opposite to each other.

5. The optical system of claim 4, wherein the first exit surface of the first lens and the second incident surface of the second lens are parallel to each other.

6. The optical system of claim 1, wherein the first incident surface of the first lens has a curved shape that is convex in a direction from the first exit surface of the first lens toward the first incident surface of the first lens, and
the second exit surface of the second lens has a curved shape that is convex in a direction from the second incident surface of the second lens toward the second exit surface of the second lens.

7. The optical system of claim 1, wherein each of a focus of the first lens and a focus of the second lens is a first focus, and
the first focus is between the first exit surface of the first lens and the second incident surface of the second lens.

8. The optical system of claim 7, wherein a spacing distance between the splitter and the first lens is equal to the first focal length, and
a spacing distance between the combiner and the second lens is equal to the second focal length.

9. The optical system of claim 1, wherein the second focal length is greater than the first focal length.

10. The optical system of claim 9, wherein the second focal length is 1.2 times or more of the first focal length and 1.6 times or less of the first focal length.

11. The optical system of claim 1, wherein an optical axis of the first lens is identical to an optical axis of the second lens.

12. The optical system of claim 1, wherein the reflected laser beam reflected from the combiner and the inverted laser beam passing through the combiner are positioned on a same straight line.

13. A laser device comprising:
a first homogenizer configured to convert a first laser beam into a first homogenizing laser beam, and including a first homogenizing optical system and a second homogenizing optical system;
a second homogenizer configured to convert a second laser beam into a second homogenizing laser beam, and including a third homogenizing optical system and a fourth homogenizing optical system; and
a third homogenizer configured to convert the first homogenizing laser beam and the second homogenizing laser beam into a third homogenizing laser beam, and each of the first homogenizing optical system, the second homogenizing optical system, the third homogenizing optical system and the fourth homogenizing optical system includes:
a splitter configured to reflect a portion of a laser beam to form a reflected laser beam, and to transmit a portion of the laser beam to form a transmitted laser beam;
a reflection module configured to reflect the reflected laser beam reflected from the splitter;
an inversion module including a first lens having a first focal length and including a first incident surface and a first exit surface opposite to the first incident surface, and a second lens having a second focal length and including a second incident surface and a second exit surface opposite to the second incident surface, in which the transmitted laser beam passing through the splitter sequentially passes through the first lens and the second lens so that the transmitted laser beam is converted into an inverted laser beam; and
a combiner configured to reflect the reflected laser beam reflected from the reflection module and to transmit the inverted laser beam emitted from the inversion module.

14. The laser device of claim 13, wherein the first homogenizer further includes a first transmission optical system configured to transmit the laser beam emitted from the first homogenizing optical system to the second homogenizing optical system, and
the second homogenizer further includes a second transmission optical system configured to transmit the laser beam emitted from the third homogenizing optical system to the fourth homogenizing optical system.

15. The laser device of claim 14, wherein the first transmission optical system includes a first reflection mirror configured to reflect the laser beam emitted from the combiner of the first homogenizing optical system, and a second reflection mirror configured to reflect the laser beam reflected from the first reflection mirror to transmit the laser beam to the splitter of the second homogenizing optical system, and
the second transmission optical system includes a third reflection mirror configured to reflect the laser beam emitted from the combiner of the third homogenizing optical system, and a fourth reflection mirror configured to reflect the laser beam reflected from the third reflection mirror to transmit the laser beam to the splitter of the fourth homogenizing optical system.

16. The laser device of claim 13, wherein the first homogenizer further includes a first lens array configured to convert the laser beam emitted from the second homogenizing optical system into the first homogenizing laser beam, and
the second homogenizer further includes a second lens array configured to convert the laser beam emitted from the fourth homogenizing optical system into the second homogenizing laser beam.

17. The laser device of claim 16, wherein each of the first lens array and the second lens array includes:
a minor-axis homogenizing lens array including a first minor-axis homogenizing lens and a second minor-axis homogenizing lens; and
a major-axis homogenizing lens array including a first major-axis homogenizing lens and a second major-axis homogenizing lens.

18. The laser device of claim 17, wherein the major-axis homogenizing lens array is between the first minor-axis homogenizing lens and the second minor-axis homogenizing lens.

19. The laser device of claim 16, wherein the first homogenizer further includes a third transmission optical system configured to transmit the laser beam emitted from the second homogenizing optical system to the first lens array, and
the second homogenizer further includes a fourth transmission optical system configured to transmit the laser beam emitted from the fourth homogenizing optical system to the second lens array.

20. The laser device of claim 19, wherein the third transmission optical system includes a first splitter configured to reflect a portion of the laser beam emitted from the second homogenizing optical system and transmit a portion of the laser beam, and a fifth reflection mirror configured to reflect the laser beam reflected from the first splitter to transmit the laser beam to the first lens array, and
the fourth transmission optical system includes a second splitter configured to reflect a portion of the laser beam emitted from the fourth homogenizing optical system and transmit a portion of the laser beam, and a sixth reflection mirror configured to reflect the laser beam reflected from the second splitter to transmit the laser beam to the second lens array.

21. The laser device of claim 20, wherein the first homogenizer further includes a first inspection device configured to inspect a dispersion characteristic of the laser beam that has passed through the first splitter, and
the second homogenizer further includes a second inspection device configured to inspect a dispersion characteristic of the laser beam that has passed through the second splitter.

22. The laser device of claim 13, wherein the third homogenizer includes:
a fifth transmission optical system configured to reflect the first homogenizing laser beam;
a sixth transmission optical system configured to reflect the second homogenizing laser beam;
a third splitter configured to reflect a portion of each of the first homogenizing laser beam reflected from the fifth transmission optical system and the second homogenizing laser beam reflected from the sixth transmission optical system, and transmit a portion of each of the first homogenizing laser beam reflected from the fifth transmission optical system and the second homogenizing laser beam reflected from the sixth transmission optical system; and
a fourth splitter configured to reflect a portion of each of the first homogenizing laser beam reflected from the third splitter and the second homogenizing laser beam transmitted through the third splitter, and transmit a portion of each of the first homogenizing laser beam reflected from the third splitter and the second homogenizing laser beam transmitted through the third splitter.

23. The laser device of claim 22, wherein the fifth transmission optical system includes a seventh reflection mirror configured to reflect the first homogenizing laser beam and an eighth reflection mirror configured to reflect the first homogenizing laser beam reflected from the seventh reflection mirror to transmit the first homogenizing laser beam to the third splitter, and
the sixth transmission optical system includes a ninth reflection mirror configured to reflect the second homogenizing laser beam to transmit the second homogenizing laser beam to the third splitter.

24. The laser device of claim 23, wherein the first homogenizing laser beam reflected from the eighth reflection mirror is incident onto a first surface of the third splitter, and
the second homogenizing laser beam reflected from the ninth reflection mirror is incident onto a second surface opposite to the first surface of the third splitter.

25. The laser device of claim 22, wherein the third homogenizer further includes a third inspection device configured to inspect waveform characteristics of the laser beam that has passed through the fourth splitter.

26. The laser device of claim 22, wherein the third homogenizer further includes a homogenizer configured to convert the first homogenizing laser beam transmitted through the third splitter and the second homogenizing laser beam reflected from the third splitter into a third homogenizing laser beam.

27. The laser device of claim 26, wherein the homogenizer is configured to further convert the laser beam reflected from the fourth splitter into the third homogenizing laser beam.
